(19) United States
(12) Patent Application Publication
(10) Pub. No.: US 2025/0162313 A1
(43) Pub. Date: May 22, 2025

(54) LIQUID DISCHARGE HEAD, LIQUID DISCHARGE DEVICE, LIQUID DISCHARGE APPARATUS, LIQUID DISCHARGE METHOD, AND NON-TRANSITORY RECORDING MEDIUM

(71) Applicants: Hiroki AKIYAMA, KANAGAWA (JP); Takahiro YOSHIDA, KANAGAWA (JP)

(72) Inventors: Hiroki AKIYAMA, KANAGAWA (JP); Takahiro YOSHIDA, KANAGAWA (JP)

(21) Appl. No.: 18/940,864

(22) Filed: Nov. 8, 2024

(30) Foreign Application Priority Data
Nov. 20, 2023 (JP) 2023-196689

(51) Int. Cl. B41J 2/045; B41J 2/205

(52) U.S. Cl. CPC B41J 2/04581; B41J 2/04593; B41J 2/2054

(57) ABSTRACT

A liquid discharge apparatus includes a liquid discharge head and circuitry. The liquid discharge head includes nozzles to discharge two or more types of droplets each having a different discharge amount onto a medium to form an image having gradation of density in accordance with an input gradation value input. The input gradation value increases from a first gradation portion to a second gradation portion higher than the first gradation portion. The circuitry causes the liquid discharge head to selectively discharge the largest droplets of the two or more types of droplets from the multiple nozzles in the second gradation portion of the gradation value, and causes the liquid discharge head to decrease a number of non-discharge nozzles that do not discharge droplets from the first gradation portion to the second gradation portion while increasing the number of non-discharge nozzles in a part of the first gradation portion.

### CROSS-REFERENCE TO RELATED APPLICATIONS

This patent application is based on and claims priority pursuant to 35 U.S.C. § 119(a) to Japanese Patent Application No. 2023-196689, filed on Nov. 20, 2023, in the Japan Patent Office, the entire disclosure of which is hereby incorporated by reference herein.

### BACKGROUND

### Technical Field

Embodiments of the present disclosure relate to a liquid discharge head, a liquid discharge device, a liquid discharge apparatus, a liquid discharge method, and a non-transitory recording medium.

### Related Art

A head control method and an image processing technology are known in which droplets, such as large droplets, medium droplets, and small droplets, each having different discharge droplet amounts are separately discharged from a liquid discharge head to express a gradation of density. More specifically, a technology is known that expresses a low gradation portion with small dot sizes of small droplets, for an intermediate gradation portion, reducing the ratio of small dot sizes and mixing medium dot sizes of medium droplets, and for a high gradation portion, reducing the ratio of medium dot sizes and mixing large dot sizes of large droplets, for the purpose of expressing gradations of density.

### SUMMARY

In an embodiment of the present disclosure, a liquid discharge apparatus includes a liquid discharge head and circuitry. The liquid discharge head includes multiple nozzles to discharge two or more types of droplets each having a different discharge amount from the multiple nozzles onto a medium to form an image having gradation of density in accordance with a gradation value input to the liquid discharge apparatus. The gradation value increases from a first gradation portion to a second gradation portion higher than the first gradation portion. The circuitry causes the liquid discharge head to selectively discharge the largest droplets of the two or more types of droplets from the multiple nozzles in the second gradation portion of the gradation value, and causes the liquid discharge head to decrease a number of non-discharge nozzles that do not discharge droplets in the multiple nozzles from the first gradation portion to the second gradation portion while increasing the number of non-discharge nozzles in a part of the first gradation portion.

In another embodiment of the present disclosure, a liquid discharge device includes the liquid discharge head and at least one of a head tank, a carriage, a supply mechanism, a maintenance mechanism, and a main-scanning moving mechanism.

In still another embodiment of the present disclosure, a liquid discharge apparatus includes the liquid discharge head and circuitry to drive the liquid discharge head to discharge liquid.

In still another embodiment of the present disclosure, a liquid discharge method includes controlling a liquid discharge head and causing the liquid discharge head to discharge, causing the liquid discharge head to discharge droplets, and causing the liquid discharge head to decrease a number of non-discharge nozzles. The controlling controls the liquid discharge head including multiple nozzles to discharge two or more types of droplets each having a different discharge amount from the multiple nozzles onto a medium to form an image having gradation of density in accordance with a gradation value input to the liquid discharge apparatus, the gradation value increasing from a first gradation portion to a second gradation portion higher than the first gradation portion. The causing the liquid discharge head causes the liquid discharge head to selectively discharge the largest droplets of the two or more types of droplets from the multiple nozzles in the second gradation portion of the gradation value. The causing the liquid discharge head causes the liquid discharge head to decrease a number of non-discharge nozzles that do not discharge droplets in the multiple nozzles from the first gradation portion to the second gradation portion while increasing the number of non-discharge nozzles in a part of the first gradation portion.

In still another embodiment of the present disclosure, a non-transitory recording medium storing a plurality of instructions which, when executed by one or more processors, causes the one or more processors to perform a method, includes controlling a liquid discharge head, causing the liquid discharge head to selectively discharge the largest droplets, and causing the liquid discharge head to decrease a number of non-discharge nozzles. The controlling controls the liquid discharge head including multiple nozzles to discharge two or more types of droplets each having a different discharge amount from the multiple nozzles onto a medium to form an image having gradation of density in accordance with an input gradation value input to a liquid discharge apparatus, the input gradation value increasing from a first gradation portion to a second gradation portion higher than the first gradation portion. The controlling causes the liquid discharge head to selectively discharge the largest droplets of the two or more types of droplets from the multiple nozzles in the second gradation portion of the gradation value. The controlling also causes the liquid discharge head to decrease a number of non-discharge nozzles that do not discharge droplets in the multiple nozzles from the first gradation portion to the second gradation portion while increasing the number of non-discharge nozzles in a part of the first gradation portion.

### BRIEF DESCRIPTION OF THE DRAWINGS

A more complete appreciation of the disclosure and many of the attendant advantages and features thereof can be readily obtained and understood from the following detailed description with reference to the accompanying drawings, wherein:

FIG. 1 is a perspective view of an image forming apparatus such that the structure or configuration inside of the image forming apparatus can be seen through, according to a first embodiment of the present disclosure;

FIG. 2 is a diagram illustrating a configuration of the image forming apparatus of FIG. 1, viewed from above;

FIG. 3 is a block diagram of a hardware configuration of the image forming apparatus of FIG. 1;

FIG. 4 is a block diagram illustrating a functional configuration of a controller;

FIG. 5 is a graph illustrating a relationship between an input level and a drop ratio according to a comparative example;

FIG. 6 is a graph illustrating the relationship between the input level and the drop ratio;

FIG. 7 is a graph illustrating the relationship between the input level and the output level;

FIG. 8A is a diagram illustrating how white pixels are formed in accordance with a drop ratio, according to a comparative example;

FIG. 8B is a diagram illustrating how white pixels are formed in accordance with a drop ratio, according to an embodiment of the present disclosure;

FIG. 9 is a graph illustrating the relationship between the input level and the drop ratio according to a second embodiment of the present disclosure;

FIG. 10 is a graph illustrating the relationship between the input level and the output level; and

FIG. 11 is a schematic diagram illustrating an electrode manufacturing apparatus to manufacture electrodes, according to a third embodiment of the present disclosure.

The accompanying drawings are intended to depict embodiments of the present invention and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

Embodiments of a liquid discharge head, a liquid discharge device, a liquid discharge apparatus, a liquid discharge method, and a non-transitory recording medium are described below in detail with reference to the accompanying drawings.

A description is given below of a liquid discharge apparatus according to embodiments of the present disclosure as an example of an image forming apparatus that discharges liquid. However, embodiments of the present disclosure are not limited to such an image forming apparatus that discharges liquid.

### First Embodiment

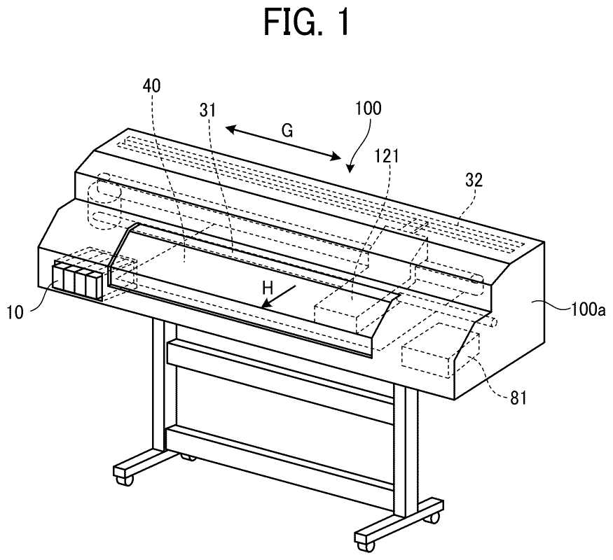

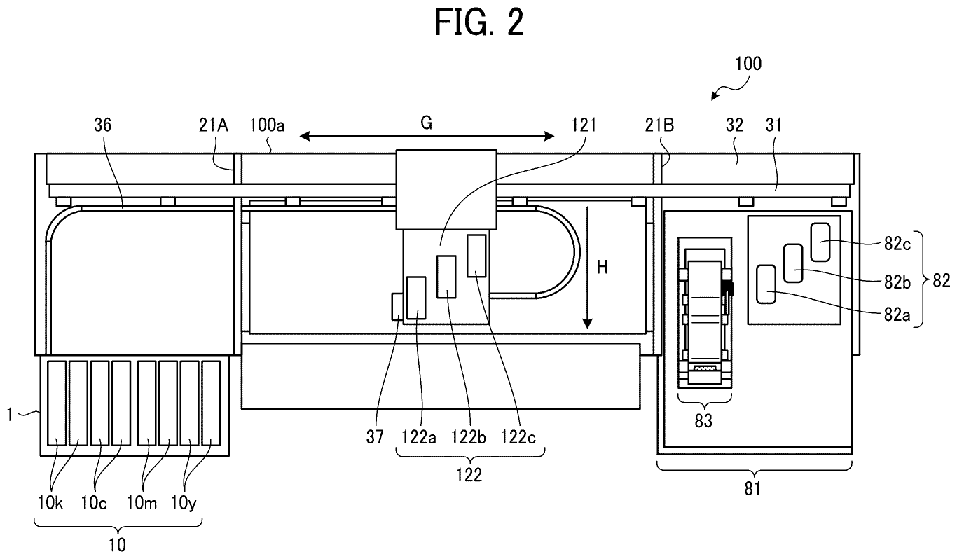

FIG. 1 is a perspective view of an image forming apparatus 100 such that the structure or configuration inside of the image forming apparatus 100 can be seen through, according to a first embodiment of the present disclosure. FIG. 2 is a diagram illustrating a configuration of the image forming apparatus 100, viewed from above. As illustrated in FIGS. 1 and 2, the image forming apparatus 100 according to the present embodiment is a wide-format serial-type inkjet recording apparatus.

In the present embodiment, the image forming apparatus that discharges liquid is applied to a wide-format serial-type inkjet recording apparatus. However, the image forming apparatus may be applied to any image forming apparatus such as a multifunction peripheral (MFP), a copier, a printer, a scanner, and a facsimile (FAX) that has at least two of a photocopying function, a printing function, a scanning function, and a facsimile (FAX) function.

As illustrated in FIGS. 1 and 2, the image forming apparatus 100 includes an apparatus body 100a and side plates 21A and 21B on the left side and right side, respectively, of the apparatus body 100a. A main guide rod 31 as a guide is laterally bridged by the side plates 21A and 21B. The image forming apparatus 100 also includes a sub guide 32 made of sheet metal. The main guide rod 31 and the sub guide 32 slidably hold a carriage 121.

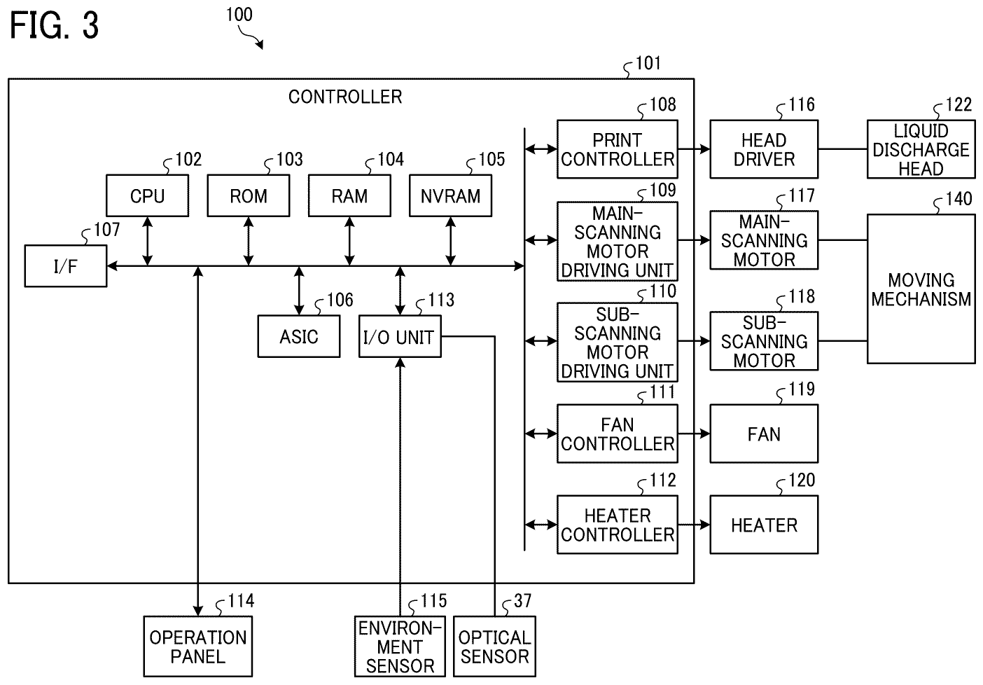

The carriage 121 moves in main scanning directions indicated by double-headed arrow G via a timing belt that is rotationally driven by a main-scanning motor 117 (see FIG. 3). By so doing, the carriage 121 relatively moves with respect to a medium 40 as a recording medium. The movement of the carriage 121 may also be referred to as scanning. The carriage 121 includes an optical sensor 37 for detecting ends of the medium 40, i.e., ends of a sheet of paper.

The optical sensor 37 is an example of a reader that outputs a read signal of an image formed in advance on the medium 40 by the image forming apparatus 100. In the present embodiment, the image forming apparatus 100 detects a defective image based on a read signal by the optical sensor 37. As the optical sensor 37, for example, a device that detects an image by reflection density and a camera that captures an image formed on the medium 40 can be used. In the present embodiment, the defective image includes a sign of abnormality which is about to occur.

The carriage 121 includes liquid discharge heads 122a, 122b, and 122c that discharge ink droplets (liquid) of respective colors such as yellow (Y), cyan (C), magenta (M), black (K), orange (O), green (G), and clear (Cl) in accordance with ink cartridges 10 mounted on the image forming apparatus 100. The three liquid discharge heads 122a, 122b, and 122c may be collectively referred to as liquid discharge heads 122, each of which may be referred to as a liquid discharge head 122 unless distinguished.

A sub-scanning motor 118 (see FIG. 3) rotates a conveyance roller to move the medium 40 in a sub-scanning direction, i.e., a direction indicated by arrow H, substantially orthogonal to the main scanning directions. As a result, the medium 40 relatively moves with respect to the liquid discharge head 122. However, the main-scanning directions and the sub-scanning direction are not necessarily substantially orthogonal to each other and may intersect with each other.

The liquid discharge head 122 includes a nozzle array including multiple nozzles arranged in the sub-scanning direction. The liquid discharge head 122 is mounted on the carriage 121 so as to discharge ink droplets downward from the nozzles. The liquid discharge heads 122a, 122b, and 122c are shifted from each other in the sub-scanning direction. The carriage 121 is provided with sub tanks for supplying ink of the respective colors to the liquid discharge heads 122.

The term “liquid discharge head” used herein is a functional component to discharge liquid through the nozzles. Liquid to be discharged from the liquid discharge head 122 is not limited to a particular liquid as long as the liquid has a viscosity or surface tension dischargeable from the liquid discharge head 122. However, preferably, the viscosity of the liquid is not greater than 30 millipascal-second (mPa s) under ordinary temperature and ordinary pressure or by heating or cooling. Examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

Examples of an energy source for generating energy to discharge liquid include a piezoelectric actuator such as a laminated piezoelectric element and a thin-film piezoelectric element.

The pressure generator used in the liquid discharge head is not limited to a particular type of pressure generator. In addition to the above-described piezoelectric actuator, which may use a laminated piezoelectric element, for example, a thermal actuator using a thermoelectric transducer such as a thermal resistor, and an electrostatic actuator including a diaphragm and opposed electrodes can be used.

The image forming apparatus 100 includes a cartridge mount 1 on which ink cartridges 10y, 10c, 10m, and 10k for the respective colors are detachably mounted. The ink cartridges 10y, 10c, 10m, and 10k may be collectively referred to as ink cartridges 10, each of which may be referred to as an ink cartridge 10 unless distinguished.

Ink in the ink cartridge 10 is supplied to the sub tank of the carriage 121 through a supply tube 36 of each color by a supply pump unit. The supply pump unit and the supply tube 36 construct a supply mechanism. Examples of the ink cartridge 10 may include an ink cartridge for white ink.

The image forming apparatus 100 includes a maintenance mechanism 81 in a non-print area on one end of the range of movement of the carriage 121 in the main scanning directions. The maintenance mechanism 81 maintains and recovers the condition of the nozzles of the liquid discharge head 122.

The maintenance mechanism 81 includes caps 82a, 82b, and 82c for covering the nozzle faces of the liquid discharge heads 122 and a wiper unit 83 for wiping the nozzle faces. The caps 82a, 82b, and 82c may be collectively referred to as caps 82, each of which may be referred to as a cap 82 unless distinguished. A replaceable waste liquid tank that stores waste liquid generated by maintenance and recovery operations is disposed below the maintenance mechanism 81 provided for the liquid discharge head 122.

The term liquid discharge device refers to the liquid discharge head 122 integrated with functional components or mechanisms, i.e., an assembly of components related to discharge of liquid. For example, the liquid discharge device includes a combination of the liquid discharge head 122 with at least one of a head tank, i.e., the sub tanks of the carriage 121, the carriage 121, the supply mechanism, the maintenance mechanism 81, or a main-scanning moving mechanism.

The above integration may be achieved by, for example, a combination in which the liquid discharge head 122 and a functional part(s) are fixed to each other through, e.g., fastening, bonding, or engaging, and a combination in which one of the liquid discharge head 122 and the functional part(s) are movably held by the other. The liquid discharge head 122 and the functional part(s) or mechanism(s) may be detachably attached to each other.

For example, the liquid discharge head 122 and the head tank are integrated to form the liquid discharge device as a single device. Alternatively, the liquid discharge head 122 and the head tank coupled with, for example, a tube may construct the liquid discharger as a single device. A unit that includes a filter may further be added to a portion between the head tank and the liquid discharge head 122 of the liquid discharge device.

In another example, the liquid discharge device may be an integrated unit in which the liquid discharge head 122 is integrated with the carriage 121.

As yet another example, the liquid discharge device is a unit in which the liquid discharge head 122 and the main-scanning moving mechanism are combined into a single unit. The liquid discharge head 122 is movably held by the main guide rod 31 which is a guide forming a part of the main-scanning moving mechanism. The liquid discharge unit may include the liquid discharge head 122, the carriage 121, and the main-scanning moving mechanism that are integrated as a single unit.

In another example, the cap 82 that forms a part of the maintenance mechanism 81 is fixed to the carriage 121 mounting the liquid discharge head 122 so that the liquid discharge head 122, the carriage 121, and the maintenance mechanism 81 are integrated as a single unit to form the liquid discharge device.

Further, in still another example, the liquid discharge device includes the supply tube 36 coupled with the liquid discharge head 122 mounting the head tank or a channel component such that the liquid discharge head 122 and the supply mechanism are integrated as a single device. Through the supply tube 36, the liquid in a liquid storage source is supplied to the liquid discharge head 122.

Examples of the main-scanning moving mechanism include the main guide rod 31 as a guide alone.

Examples of the supply mechanism include the supply tube 36 alone and the cartridge mount 1 alone.

FIG. 3 is a block diagram of a hardware configuration of the image forming apparatus 100. As illustrated in FIG. 3, the image forming apparatus 100 includes a controller 101, an operation panel 114, an environmental sensor 115, an optical sensor 37, a head driver 116, the main-scanning motor 117, the sub-scanning motor 118, a fan 119, a heater 120, the liquid discharge head 122, and a moving mechanism 140.

As illustrated in FIG. 3, the controller 101 includes a central processing unit (CPU) 102, a read-only memory (ROM) 103, a random-access memory (RAM) 104, a non-volatile random-access memory (NVRAM) 105, an application-specific integrated circuit (ASIC) 106, an interface (I/F) 107, a print controller 108, a main-scanning motor driving unit 109, a sub-scanning motor driving unit 110, a fan controller 111, a heater controller 112, and an input/output (I/O) unit 113. The controller 101 may include a configuration other than the above.

The CPU 102, the ROM 103, the RAM 104, the NVRAM 105, the ASIC 106, the I/F 107, the print controller 108, the main-scanning motor driving unit 109, the sub-scanning motor driving unit 110, the fan controller 111, the heater controller 112, and the I/O unit 113 are connected to each other via, for example, a bus so as to communicate with each other.

The CPU 102 controls the operation of the entire image forming apparatus 100. Specifically, the CPU 102 executes programs stored in, for example, the ROM 103 to implement functions of the above configuration.

The ROM 103 stores the programs to be executed by the CPU 102 and other fixed data. The RAM 104 temporarily stores image data and other data. The NVRAM 105 can retain data even while the power supply of the image forming apparatus 100 is shut off. The ASIC 106 is a circuit to perform image processing, such as various signal processing and sorting, and processing of input and output signals for controlling the entire image forming apparatus 100.

The I/F 107 is an interface circuit that transmits and receives data and signals to and from a host. Specifically, the I/F 107 receives print data, i.e., image data, generated by a printer driver of the host such as a data processor, an image reading device, or an imaging device via a cable or a network. In other words, the printer driver of the host may generate and output the image data to the controller 101.

The print controller 108 is a circuit to generate a drive waveform for driving the liquid discharge head 122 and outputs the print data accompanied by various data to the head driver 116. A pressure generator of the liquid discharge head 122 is selectively driven based on the print data and generates pressure to cause the liquid discharge head 122 to discharge liquid (ink) from the nozzles.

The main-scanning motor driving unit 109 is a circuit to drive the main-scanning motor 117. The sub-scanning motor driving unit 110 is a circuit to drive the sub-scanning motor 118. The fan controller 111 is a circuit to control the output of the fan 119 to blow air at a predetermined temperature and air volume.

The heater controller 112 is a circuit to control the heater 120 such that the heater is heated to a set temperature. The I/O unit 113 is a circuit to acquire data from the environmental sensor 115 and extracts data for controlling each unit of the image forming apparatus 100. The I/O unit 113 also receives detection signals from various sensors such as the optical sensor 37, other than the environmental sensor 115.

The operation panel 114 is a device to input and display various types of data such as a resolution specified by a user. The operation panel 114 is connected to, for example, the CPU 102 via the bus of the controller 101 to communicate with each other.

The environmental sensor 115 is a sensor to detect, for example, the ambient temperature and ambient humidity. The environmental sensor 115 is connected to the I/O unit 113 of the controller 101.

The head driver 116 is a circuit to drive the liquid discharge head 122. The head driver 116 selectively applies drive pulses forming the drive waveform given from the print controller 108 to the pressure generator of the liquid discharge head 122 based on the input image data, e.g., dot pattern data. The head driver 116 is connected to the print controller 108 of the controller 101. The discharge amount of ink droplets (liquid) is controlled by, for example, controlling the amplitude of the drive waveform input to the pressure generator of the liquid discharge head 122. However, the discharge amount may be controlled using other parameters.

The main-scanning motor 117 is a device that is driven to rotate the timing belt to move the carriage 121 including the liquid discharge head 122 in the main scanning direction, i.e., the direction indicated by arrow G. The main-scanning motor 117 is connected to the main-scanning motor driving unit 109 of the controller 101.

The sub-scanning motor 118 is a device that is driven to operate the conveyance roller to convey the medium 40, which is an object onto which liquid (ink) is discharged by the liquid discharge head 122, in the sub-scanning direction. The sub-scanning motor 118 is connected to the sub-scanning motor driving unit 110 of the controller 101.

The moving mechanism 140 moves the liquid discharge head 122 and the medium 40 relative to each other. The moving mechanism 140 includes the main guide rod 31, the sub guide 32, the carriage 121, and the conveyance roller to construct the main-scanning moving mechanism.

The moving mechanism 140 moves the liquid discharge head 122 and the medium 40 relative to each other in the main scanning directions by, for example, the main guide rod 31, the sub guide 32, and the carriage 121. The moving mechanism 140 moves the liquid discharge head 122 and the medium 40 relative to each other in the sub-scanning direction by, for example, the conveyance roller that conveys the medium 40. In the present embodiment, the relative movement in the sub-scanning direction by the moving mechanism 140 is intermittent. In such intermittent movement, the moving mechanism 140 alternately moves and stops at least one of the liquid discharge head 122 and the medium 40 relative to the other.

The fan 119 is driven to accelerate the convection of air inside the image forming apparatus 100 so as to prevent the temperature from increasing excessively due to the accumulation of warmed air in an upper portion of the image forming apparatus 100. The fan 119 is connected to the fan controller 111 of the controller 101.

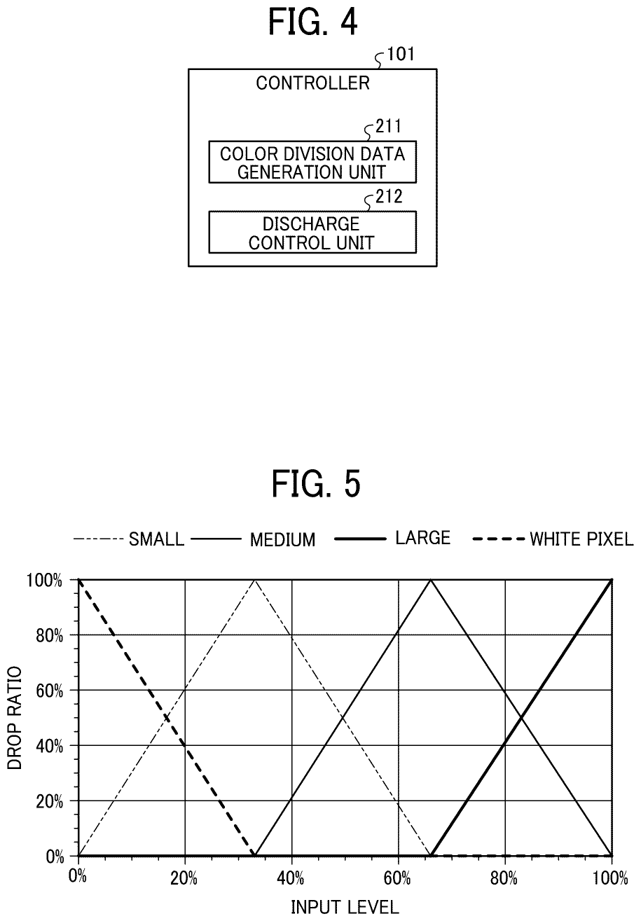

FIG. 4 is a block diagram of a functional configuration of the controller 101. The description of the components overlapping those in FIG. 3 may be omitted.

As illustrated in FIG. 4, the controller 101 includes a color division data generation unit 211 and a discharge control unit 212. The discharge control unit 210 controls the discharge of ink.

In the present embodiment, the controller 101 includes the color division data generation unit 211 and the discharge control unit 212.

When the color division data generation unit 211 receives image data to be printed, the color division data generation unit 211 generates color division data for each color of ink used in the image forming apparatus 100 from the received image data (an example of an input image data). For example, when the image forming apparatus 100 uses inks of C, M, Y, and K, the color division data generation unit 211 generates color division data for each color of C, M, Y, and K from the received image data.

The discharge control unit 212 applies a dot-data generation mask to the color division data of each color generated by the color division data generation unit 211 to generate dot-data. The dot data generation mask is, for example, a dither mask having a threshold value used in halftone processing. At this time, the discharge control unit 212 converts the image data into the dot data including at least two types of dots.

In the present embodiment, the dot data includes four gradations including a dot of a small droplet, a dot of a large droplet having a larger volume than the dot of the small droplet, a dot of a medium droplet having a larger volume than the dot of the small droplet and a smaller volume than the dot of the large droplet, and no dot (i.e., liquid droplets are not discharged). In the present embodiment, for example, the discharge volume of one small droplet is 6 pico liter (pL), the discharge volume of one medium droplet is 12 pL, and the discharge volume of one large droplet is 18 pL.

The CPU 102 executes a predetermined program. In so doing, the controller 101 implements the above-described functions of the color division data generation unit 211 and the discharge control unit 212. The controller 101 may implement a part or all of these functions by one or multiple processing circuits.

The processing circuit or circuitry includes a programmed processor to execute each function by software, such as a processor implemented by an electronic circuit, and devices, such as an application-specific integrated circuit (ASIC), a digital signal processor (DSP), a field-programmable gate array (FPGA), and conventional circuit components arranged to perform the recited functions.

The controller 101 controls the liquid discharge head 122 and the moving mechanism 140 so that the liquid discharge head 122 and the medium 40 are moved relative to each other multiple times to apply ink onto the medium 40. The ink that has been applied onto the medium 40 is fixed to the medium 40 to form dots in an image. More specifically, one ink droplet that is discharged from the liquid discharge head 122 lands on the medium 40, and then is dried and fixed to the medium 40. Thus, one dot in the image is formed on the medium 40. The image is formed as an aggregate of multiple dots.

An example of a selective discharge for each type of dot, which may be referred to as a droplet type in the following description, by the discharge control unit 212 will be described below.

FIG. 5 is a graph illustrating a relationship between an input level and a drop ratio according to a comparative example. In FIG. 5, the horizontal axis represents the input level, i.e., an input gradation value, and the vertical axis represents the drop ratio. The input level represents the level of density. In the gray scale representation, 0% of the input level represents white and 100% of the input level represents black. The drop ratio represents the percentage of usage of small droplets, medium droplets, or large droplets or dots at a given time. The drop ratio of 0% indicates that any of the dots is not formed, and the drop ratio of 100% indicates that the entire surface is filled with dots.

In FIG. 5, “small” represents the small droplet or a small dot size, “medium” represents the medium droplet or a medium dot size, “large” represents the large droplet or a large dot size, and “white pixel” indicates that no liquid droplets are discharged.

In the example illustrated in FIG. 5, when the input level is 0%, the drop ratio of any of the small droplet, the medium droplet, and the large droplet is 0%, which indicates that no liquid droplets are discharged. Accordingly, the percentage of usage of the white pixels is 100%. When the input level is 16.7%, the percentage of usage of the small droplets is 50%, and the use ratios of the medium droplets and the large droplets are 0%. Accordingly, the percentage of usage of the white pixels is 50%. Further, when the input level is 50%, the percentage of usage of the small and medium droplets is 50% and the percentage of usage of the large droplets is 0%. Thus, the percentage of usage of the white pixels is 0%.

In a gradation expression as illustrated in FIG. 5, the small droplets are used up to the drop ratio of 100%, then the small droplets start to be replaced with the medium droplets. When the drop ratio of the medium droplets reaches 100%, the medium droplets start to be replaced with the large droplets. Accordingly, smooth gradation can be expressed.

However, in the example illustrated in FIG. 5, the drop ratio of the white pixels is 0% at a time at which the input level is 33%. Accordingly, the airflow due to the discharged droplets themselves is large.

When the distance from the nozzles of the liquid discharge head 122 to the medium 40 is short, which is typically about 1 to 2 mm, the discharged droplets land on the medium 40 before being affected by the airflow. For this reason, landing position deviation of droplets and jetting deflection of discharged droplets are unlikely to occur. However, when the distance from the nozzles of the liquid discharge head 122 to the medium 40 is long, the landing position deviation of droplets and the jetting deflection of discharged droplets may occur due to the influence of the airflow caused by the discharged droplets themselves. In particular, when the size of droplets, such as the small droplets or the medium droplets, is relatively small, the droplets are more likely to be affected by the airflow caused by the discharged droplets themselves. Accordingly, the landing position deviation of droplets and jetting deflection of discharged droplets are more likely to occur.

For this reason, in the present embodiment, discharge airflows are reduced to prevent the interference between the discharge airflows. Accordingly, the jetting deflection of discharged droplets is prevented. This will be described in detail below.

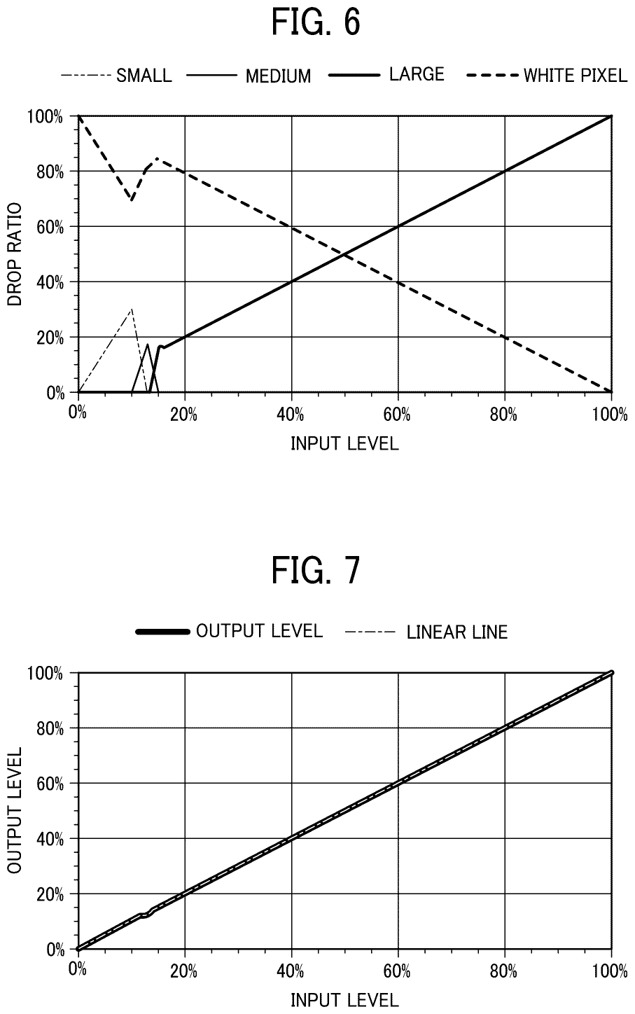

FIG. 6 is a graph illustrating the relationship between the input level and the drop ratio, according to the present embodiment. FIG. 7 is a graph illustrating the relationship between the input level and the output level, according to the present embodiment. In FIG. 6, the horizontal axis represents the input level, i.e., the input gradation value, and the vertical axis represents the drop ratio. In FIG. 7, the horizontal axis represents the input level, i.e., the input gradation value, and the vertical axis represents the output level, i.e., the discharge volume of all droplet types of liquid droplets.

The droplet types that are used for printing are controlled and replaced with each other as illustrated in FIG. 6. For example, as illustrated in FIG. 6, the discharge control unit 212 converts input image data into dot data so as to increase the ratio of dots of the small droplets and the medium droplets among all dots and decrease the ratio of dots of the large droplets among all dots in a region having a low gradation value, as compared with a region having a high gradation value. The region that has a low gradation value and the region that has a high gradation value higher than the low gradation value may also be referred to simply as a first gradation portion and a second gradation portion, respectively, in the following description.

More specifically, as illustrated in FIG. 6, in the present embodiment, the discharge control unit 212 keeps the percentage of usage of the small droplets low and starts using the medium droplets from the low input level of 10%. The discharge control unit 212 also decreases the percentage of usage of the small droplets from the input level of 10% at which the medium droplets start to be used.

In the present embodiment, the discharge control unit 212 increases the drop ratio, i.e., the number of discharge nozzles, of the medium droplets up to 15%.

Similarly, in the present embodiment, the discharge control unit 212 also reduces the percentage of usage of the medium droplets, and also reduces the percentage of usage of the medium droplets from the input level of 13% at which the large droplets start to be used. The discharge control unit 212 stops using the medium droplets at the input level of 15% before the input level reaches 100%. The discharge control unit 212 performs such control because the large droplets are less likely to be affected by airflows than the medium droplets and the small droplets, and the large droplets spread wider on the medium 40 than the medium droplets and the small droplets. As a result, the appearance of the image that is formed on the medium 40 is unlikely to change.

As illustrated in FIG. 7, when the percentage of usage of the small droplets, the medium droplets, and the large droplets is determined, preferably, the output level is substantially linearly changed with respect to the input level. In other words, the discharge control unit 212 performs control such that the ratio of the output level, i.e., the discharge volume of all droplet types of liquid droplets, does not decrease when the input level, i.e., the input gradation value, increases. The output level at this time may be an adhesion amount of liquid per unit area, or may be image density. The linear relationship between the output level and the input level can minimize the influence of a gradation jump in, for example, a y curve and color matching for determining the final color tone of an image.

As described above, the discharge control unit 212 causes only the largest droplets of the two or more types of liquid droplets to be discharged from the nozzles in a high gradation portion of the input gradation value. At the same time, the discharge control unit 212 causes the number of nozzles that do not discharge droplets, i.e., the white pixels, among all nozzles to increase without linearly decreasing from a low gradation portion to a high gradation portion of the input gradation value.

In other words, the discharge control unit 212 controls only the size of dots to perform patterning in the high gradation portion of the input gradation value. At the same time, the discharge control unit 212 controls such that the percentage of pixels in which dots are not arranged with respect to the input gradation value increases from the low gradation portion toward the high gradation portion.

With reference to the graph of FIG. 6, a description is given of the reason why the white pixels temporarily increase when the percentage of usage of the small droplets is reduced and the medium droplets start to be used from the low input level of 10%.

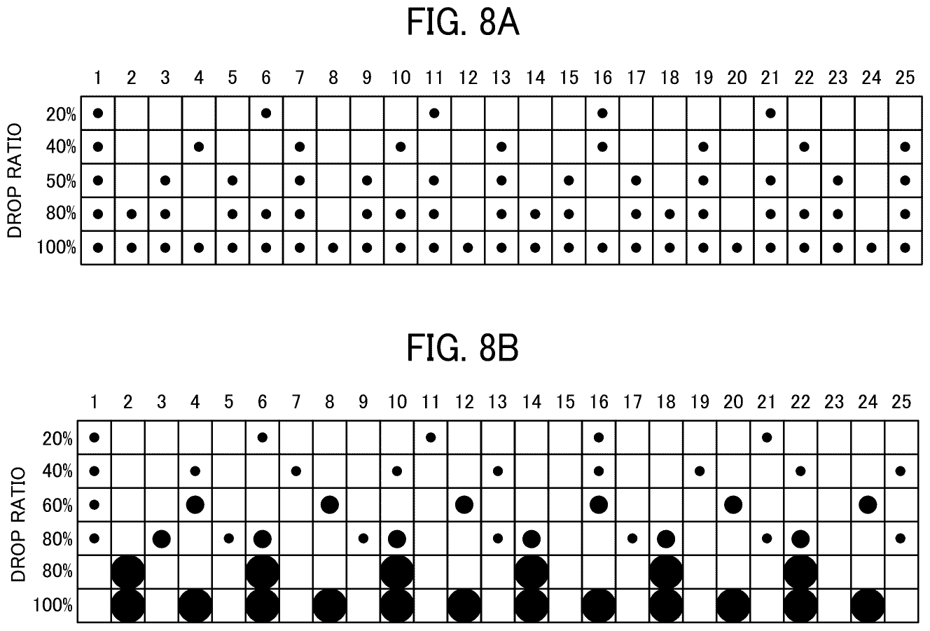

FIG. 8A is a diagram illustrating how white pixels are formed in accordance with a drop ratio, according to a comparative example. FIG. 8B is a diagram illustrating how white pixels are formed in accordance with a drop ratio, according to an embodiment of the present disclosure. Each empty square without a dot in FIGS. 8A and 8B corresponds to the white pixel. As illustrated in FIG. 8A, in the comparative example, when the drop ratio increases using the small droplets, the number of the empty squares, in other words, the white pixels decrease. At this time, when the drop ratio is 100%, the ink is discharged from all the nozzles. In other words, when the drop ratio is 100%, the ink is discharged from a large number of nozzles. For this reason, the ink droplets that are discharged from a large number of nozzles are likely to be affected by the airflows caused by the discharged ink droplets themselves.

By contrast, as illustrated in FIG. 8B, in the present embodiment, pixels that are drawn with the small droplets are replaced with the medium droplets or the large droplets. Accordingly, the number of nozzles that discharge ink droplets is reduced without changing the image density. Reducing the number of nozzles for discharging ink droplets as described above can reduce the influence of the airflows caused by the discharged ink droplets themselves.

At the same time, compared with a case in which the drop ratio is 100% and the small droplets are used, the number of empty squares, i.e., the white pixels increases when the small droplets are replaced with the medium droplets or the large droplets. In other words, in the graph of FIG. 6, when the percentage of usage of the small droplets is reduced and the medium droplets start to be used from the low input level of 10%, the white pixel temporarily increases.

As described above, according to the present embodiment, the percentage of usage of the small droplets is reduced, and the medium droplets start to be used from, for example, the low input level of 10%. The percentage of usage of the small droplets is also decreased from the input level of 10% at which the medium droplets start to be used. The use of medium droplets increases up to the input level of 15%. However, to achieve a similar print density, the number of nozzles that discharge medium droplets can be reduced compared with a case in which the nozzles that discharge small droplets are used. Moreover, when the print density is low, increasing the number of white pixels allows the number of non-discharge nozzles to be reduced despite the increase in print density. Accordingly, compared with a configuration in which the number of non-discharge nozzles does not decrease, the above-described configuration can efficiently reduce the number of droplets to be simultaneously discharged. As a result, the influence of airflows generated by the droplets discharged from the nozzles, i.e., discharge airflows, can be prevented, and the interference between the discharge airflows can be prevented. Accordingly, the landing position deviation of droplets and the jetting deflection of discharged droplets can be prevented, and white streaks and black streaks at joint portions between the liquid discharge heads 122a, 122b, and 122c can be prevented.

A program to be executed on the image forming apparatus 100 according to the present embodiment is recorded and provided for a computer-readable recording medium, such as a compact disc-read only memory (CD-ROM), a flexible disk (FD), a compact disc-recordable (CD-R), or a digital versatile disc (DVD), in a file in installable or executable format.

Alternatively, the program that is executed on the image forming apparatus 100 according to embodiments of the present disclosure may be stored in a computer connected to a network such as the Internet and downloaded via the network. The program that is executed on the image forming apparatus 100 according to embodiments of the present disclosure may be provided or distributed via a network such as the Internet.

Further, the program that is executed on the image forming apparatus 100 embodiments of the present disclosure may be provided by being incorporated in advance in, for example, the ROM 103.

The program that is executed on the image forming apparatus 100 according to embodiments of the present disclosure has a modular configuration including the above-described units (the color division data generation unit 211 and the discharge control unit 212). The CPU 102 (i.e., a processor) serving as actual hardware reads the program from the recording medium described above and executes the program so as to load these units described above on a main storage device to implement the color division data generation unit 211 and the discharge control unit 212 on the main storage device.

### Second Embodiment

A description is given below of the image forming apparatus 100 according to a second embodiment of the present disclosure.

The second embodiment is different from the first embodiment in that the percentage of usage and the range of usage of the small droplets and the medium droplets are expanded as compared with those in the first embodiment, and the amount of increase of the white pixels is reduced. In the following description of the second embodiment, descriptions of elements similar to those in the first embodiment are omitted, and differences from the first embodiment are described.

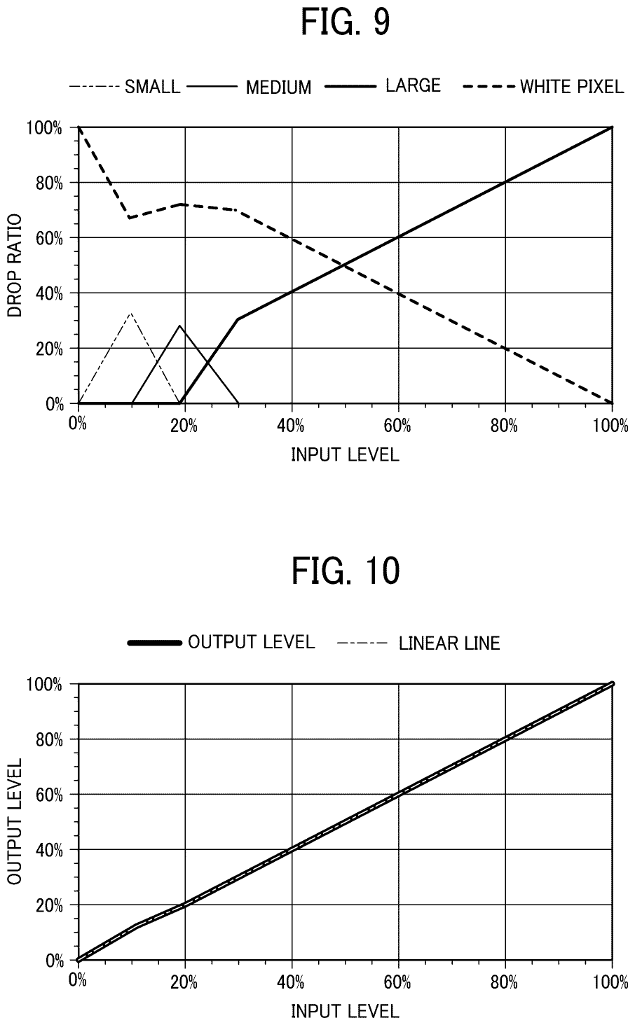

FIG. 9 is a graph illustrating the relationship between the input level and the drop ratio according to the second embodiment, and FIG. 10 is a graph illustrating the relationship between the input level and the output level.

As illustrated in FIG. 9, in the present embodiment, the discharge control unit 212 keeps the percentage of usage of the small droplets low and starts using the medium droplets from the low input level of 10%. The discharge control unit 212 also decreases the percentage of usage of the small droplets from the input level of 10% at which the medium droplets start to be used.

By contrast, in the present embodiment, the discharge control unit 212 increases the percentage of usage of the medium droplets until the input level reaches about 20% and decreases the percentage of usage of the medium droplets from the input level of about 20% at which the large droplets start to be used. The discharge control unit 212 stops using the medium droplets at the input level of 30%.

As illustrated in FIG. 10, the discharge control unit 212 substantially linearly changes the output level with respect to the input level. In the present embodiment, the percentage of usage and the range of usage of the medium droplets are expanded as compared with those in the first embodiment. However, the output level substantially linearly changes with respect to the input level, and the white pixels also monotonically decrease from the low gradation value to the high gradation value of the input level.

The influence on an image, such as the white streaks and the black streaks, due to the landing position deviation of droplets or the jetting deflection of discharged droplets varies depending on, for example, liquid (ink) and a medium 40 to be used, the distance from the nozzles to the medium 40, or a printing speed. Reducing the percentages of usage of the small droplets and the medium droplets can prevent the deviation of landing positions and the jetting deflection of discharged droplets from influencing an image. However, the graininess of the image is likely to deteriorate. For this reason, it is necessary to strike a balance between the influence on the image and the graininess of the image by printing conditions.

The present embodiment aims to enhance the graininess in the low gradation portion of the input level as compared with the first embodiment.

Compared with the first embodiment, in the present embodiment, the percentages of usage and the range of usage of the small droplets and the medium droplets are expanded, and the amount of increase of the white pixels is reduced. However, the output level is substantially linearly changed with respect to the input level, and the white pixels remain at any input level except for 100%. Accordingly, the number of liquid droplets to be simultaneously discharged is reduced. As a result, the influence of airflows, i.e., discharge airflows, generated by the liquid droplets discharged from the nozzles can be prevented, and the interference between the discharge airflows can be prevented. Accordingly, the landing position deviation of droplets and the jetting deflection of discharged droplets can be prevented, and white streaks and black streaks at the joint portions between the liquid discharge heads 122a, 122b, and 122c can be prevented.

### Third Embodiment

A description is given below of the image forming apparatus 100 according to a third embodiment of the present disclosure. Redundant descriptions of similar features in the first to third embodiments will be omitted in the following description. A description is given below of the features of the third embodiment different from the features of the first and second embodiments.

### Electrode Manufacturing Apparatus

The liquid discharge apparatus according to the present embodiment may also include an apparatus for manufacturing an electrode and an electrochemical element that is also referred to as an electrode manufacturing apparatus. The electrode manufacturing apparatus according to the present embodiment is described below.

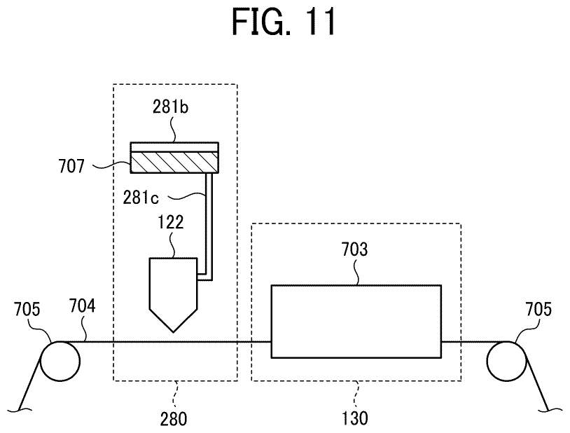

FIG. 11 is a schematic diagram illustrating the electrode manufacturing apparatus to manufacture electrodes in an electrode manufacturing method, according to the third embodiment. The electrode manufacturing apparatus is an apparatus for manufacturing an electrode including a layer containing an electrode material by discharging a liquid composition using a head module including the liquid discharge head 122 described above in the first embodiment and the second embodiment.

### Device for Forming Layer Containing Electrode Material and Process of Forming Layer Containing Electrode Material

A discharge device in the electrode manufacturing apparatus illustrated in FIG. 11 is a discharge process device 280 according to embodiments of the present disclosure. The liquid discharge head 122 of the discharge process device 280 discharges a liquid composition. By so doing, the liquid composition is applied onto an object, and a liquid composition layer is formed on the object. The object, which may also be referred to as a discharge object in the following description, is not particularly limited and may be appropriately selected depending on the intended purpose, as long as the object is an object on which a layer containing an electrode material is to be formed. Examples of the object include an electrode substrate, i.e., a current collector, an active material layer, and a layer containing a solid electrode material. The object may be an electrode mixture layer containing an active material on an electrode substrate, i.e., a current collector. The discharge device and a discharge process may be a device and a process of forming a layer containing an electrode material by directly discharging a liquid composition as long as the layer containing an electrode material can be formed on a discharge object. The discharge device and the discharge process may be a device and a process of forming a layer containing an electrode material by indirectly discharging a liquid composition.

### Other Configurations and Other Processes

Other configurations included in the electrode manufacturing apparatus for manufacturing an electrode mixture layer are not particularly limited and may be appropriately selected depending on the intended purpose, as long as the effects of the present embodiment are not impaired. Other processes included in the method for producing an electrode mixture layer are not particularly limited and may be appropriately selected depending on the intended purpose, as long as the effects of the present embodiment are not impaired. For example, the heating unit and the heating process are examples of the configuration and the process included in the electrode manufacturing apparatus and the manufacturing method of the electrode mixture layer.

### Heater and Heating Process

A heater 703 that is provided for the electrode manufacturing apparatus for manufacturing an electrode mixture layer is a unit that heats the liquid composition discharged by the discharge device. The heating process included in the method for manufacturing an electrode mixture layer is a process of heating the liquid composition discharged in the discharging process. The liquid composition is heated to dry the liquid composition layer.

### Structure to Form a Layer Containing Electrode Material by Direct Discharge of Liquid Composition

As an example of the electrode manufacturing apparatus, an electrode manufacturing apparatus that forms an electrode mixture layer containing an active material on an electrode substrate, i.e., a current collector, is described below. As illustrated in FIG. 11, the electrode manufacturing apparatus includes the discharge process device 280 and a heating process unit 130. The discharge process device 280 performs a step of applying a liquid composition onto a print base material 704 having a discharge object to form a liquid composition layer. The heating process unit 130 performs a process of heating the liquid composition layer to obtain an electrode mixture layer.

The electrode manufacturing apparatus includes a conveyor 705 that conveys the print base material 704. The conveyor 705 conveys the print base material 704 to the discharge process device 280 and the heating process unit 130 in this order at a preset speed. A method for manufacturing the print base material 704 having the discharge object such as an active material layer is not particularly limited, and a known method can be appropriately selected. The discharge process device 280 includes the liquid discharge head 122 that performs an application process of applying a liquid composition 707 onto the print base material 704, a storage container 281b that stores the liquid composition 707, and a supply tube 281c that supplies the liquid composition 707 stored in the storage container 281b to the liquid discharge head 122.

The discharge process device 280 discharges the liquid composition 707 from the liquid discharge head 122 so that the liquid composition 707 is applied onto the print base material 704 to form a liquid composition layer in a thin film shape. The storage container 281b may be integrated with an apparatus for manufacturing the electrode-mixture layer or may be detachable from the apparatus for manufacturing the electrode-mixture layer. The storage container 281b may be a container additionally attachable to a container integrated with the apparatus for manufacturing the electrode-mixture layer or a container detachable from the apparatus for manufacturing the electrode mixture layer.

The storage container 281b and the supply tube 281c can be selected as desired as long as the liquid composition 707 can be stably stored and supplied to the liquid discharge head 281a.

The heating process unit 130 performs a solvent removal process of heating and removing the solvent remaining in the liquid composition layer. Specifically, the solvent that remains in the liquid composition layer is heated and dried by the heater 703 of the heating process unit 130. Accordingly, the solvent is removed from the liquid composition layer. Thus, the electrode mixture layer is formed. The solvent removal process in the heating process unit 130 may be performed under reduced pressure.

The heater 703 is not particularly limited and may be appropriately selected depending on the intended purpose.

For example, the heater 703 may be a substrate heater, an infrared (IR) heater, or a hot air heater.

The heater 703 may be a combination of at least two of the substrate heater, the IR heater, and the hot air heater. A heating temperature and heating time can be appropriately selected according to a boiling point of the solvent contained in the liquid composition 707 or the thickness of a formed film.

The electrode manufacturing apparatus according to the embodiment of the present disclosure is used to discharge the liquid composition onto a desired target place of the discharge target. The electrode mixture layer can be suitably used as, for example, a part of the configuration of an electrochemical element. The configuration of the electrochemical element other than the electrode mixture layer is not particularly limited, and a known configuration can be appropriately selected. For example, as a configuration other than the electrode mixture layer, the electrochemical element may include a positive electrode, a negative electrode, a separator, for example.

In the above-described embodiments, the liquid discharge apparatus includes the liquid discharge head 122 or the liquid discharge device and drives the liquid discharge head 122 to discharge liquid. The liquid discharge apparatus may be, for example, any apparatus that can discharge liquid to a medium onto which liquid can adhere or any apparatus to discharge liquid toward gas or into a different liquid.

The liquid discharge apparatus may include devices to feed, convey, and eject the material on which liquid can adhere. The liquid discharge apparatus may further include a pretreatment apparatus to coat a treatment liquid onto the material, and a post-treatment apparatus to coat a treatment liquid onto the material, onto which the liquid has been discharged.

The liquid discharge apparatus may be, for example, an image forming apparatus to form an image on a sheet by discharging ink, or a three-dimensional fabrication apparatus to discharge fabrication liquid to a powder layer in which powder material is formed in layers, so as to form a three-dimensional object.

The liquid discharge apparatus is not limited to an apparatus to discharge liquid to visualize meaningful images, such as letters or figures. For example, the liquid discharge apparatus may be an apparatus to form meaningless images, such as meaningless patterns, or fabricate three-dimensional images.

The above-described material onto which liquid can adhere represents a material on which liquid is at least temporarily adhered, a material on which liquid is adhered and fixed, or a material into which liquid is adhered to permeate. Examples of the material on which liquid can adhere include recording media, such as paper sheet, recording paper, recording sheet of paper, film, and cloth, electronic component, such as electronic substrate and piezoelectric element, and media, such as powder layer, organ model, and testing cell. The material on which liquid can adhere includes any material on which liquid can adhere, unless particularly limited.

Examples of the material onto which liquid can adhere include any materials on which liquid can adhere even temporarily, such as paper, thread, fiber, fabric, leather, metal, plastic, glass, wood, and ceramic.

The liquid is not limited to a particular liquid as long as the liquid has a viscosity or surface tension to be discharged from the liquid discharge head 122. However, preferably, the viscosity of the liquid is not greater than 30 millipascal-second (mPa·s) under ordinary temperature and ordinary pressure or by heating or cooling. Examples of the liquid to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Examples of the material to be discharged include a solution, a suspension, or an emulsion including, for example, a solvent, such as water or an organic solvent; a colorant, such as dye or pigment; a functional material, such as a polymerizable compound, a resin, or a surfactant; a biocompatible material, such as deoxyribonucleic acid (DNA), amino acid, protein, or calcium; and an edible material, such as a natural colorant. Such a solution, a suspension, or an emulsion can be used for, e.g., inkjet ink; surface treatment liquid; a liquid for forming an electronic element component, a light-emitting element component, or an electronic circuit resist pattern; or a material solution for three-dimensional fabrication.

The liquid discharge apparatus may be an apparatus to move the liquid discharge head 122 and the medium onto which liquid can adhere relative to each other. However, the liquid discharge apparatus is not limited to such an apparatus. For example, the liquid discharge apparatus may be a serial head apparatus that moves the liquid discharge head 122 or a line head apparatus that does not move the liquid discharge head 122.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particle of the raw material.

Aspects of the present disclosure are, for example, as follows.

### First Aspect

A liquid discharge apparatus includes a liquid discharge head and circuitry. The liquid discharge head includes multiple nozzles to discharge two or more types of droplets each having a different discharge amount from the multiple nozzles onto a medium to form an image having gradation of density in accordance with a gradation value input to the liquid discharge apparatus. The gradation value increases from a first gradation portion to a second gradation portion higher than the first gradation portion. The circuitry causes the liquid discharge head to selectively discharge the largest droplets of the two or more types of droplets from the multiple nozzles in the second gradation portion of the gradation value, and causes the liquid discharge head to decrease a number of non-discharge nozzles that do not discharge droplets in the multiple nozzles from the first gradation portion to the second gradation portion while increasing the number of non-discharge nozzles in a part of the first gradation portion.

### Second Aspect

In the liquid discharge apparatus according to the first aspect, the discharge controller controls the liquid discharge head to linearly increase total discharge amount of two or more types of droplets discharged from the multiple nozzles with respect to the increase in the input gradation value input to the liquid discharge apparatus.

### Third Aspect

In the liquid discharge apparatus according to the first or second aspect, the discharge controller controls the liquid discharge head to discharge the smallest droplets of the two or more types of droplets only when the gradation value is equal to or smaller than 13%.

### Fourth Aspect

In the liquid discharge apparatus according to any one of the first to third aspect, the discharge controller controls the liquid discharge head to discharge the smallest droplets of the two or more types of droplets only when the input gradation value is equal to or smaller than 10%.

### Fifth Aspect

In the liquid discharge apparatus according to the first or second aspect, the discharge controller causes the liquid discharge head to selectively discharge three or more types of droplets each having a different discharge droplet amount from the nozzles. The discharge controller causes the liquid discharge head to discharge the second smallest droplets of the three or more types of droplets when the input gradation value is equal to or smaller than 15%.

### Sixth Aspect

In the liquid discharge apparatus according to the first or second aspect, the discharge controller causes the liquid discharge head to decrease the number of non-discharge nozzles from the second gradation portion to the first gradation portion at least in a part having the input gradation value of equal to or smaller than 20%.

### Seventh Aspect

In the liquid discharge apparatus according to the first or second aspect, the discharge controller controls the liquid discharge head to discharge at least two or more types of droplets each a having different size from the multiple nozzles in a portion of the gradation value in which the number of the non-discharge nozzles decreases from the first gradation portion to the second gradation portion in the gradation value.

### Eighth Aspect

A liquid discharge device includes the liquid discharge head according to any one of the first to seventh aspect, and at least one of a head tank, a carriage, a supply mechanism, a maintenance device, and a main-scanning moving mechanism.

### Ninth Aspect

A liquid discharge device includes the liquid discharge head according to any one of the first to seventh aspect, and a discharge controller to drive the liquid discharge head to cause the liquid discharge head to discharge liquid.

### Tenth Aspect

A liquid discharge method includes controlling a liquid discharge head and causing the liquid discharge head to discharge, causing the liquid discharge head to discharge droplets, and causing the liquid discharge head to decrease a number of non-discharge nozzles. The controlling controls the liquid discharge head including multiple nozzles to discharge two or more types of droplets each having a different discharge amount from the multiple nozzles onto a medium to form an image having gradation of density in accordance with a gradation value input to the liquid discharge apparatus, the gradation value increasing from a first gradation portion to a second gradation portion higher than the first gradation portion. The causing the liquid discharge head causes the liquid discharge head to selectively discharge the largest droplets of the two or more types of droplets from the multiple nozzles in the second gradation portion of the gradation value. The causing the liquid discharge head causes the liquid discharge head to decrease a number of non-discharge nozzles that do not discharge droplets in the multiple nozzles from the first gradation portion to the second gradation portion while increasing the number of non-discharge nozzles in a part of the first gradation portion.

### Eleventh Aspect

A non-transitory recording medium storing a plurality of instructions which, when executed by one or more processors, causes the one or more processors to perform a method, includes controlling a liquid discharge head, causing the liquid discharge head to selectively discharge the largest droplets, and causing the liquid discharge head to decrease a number of non-discharge nozzles. The controlling controls the liquid discharge head including multiple nozzles to discharge two or more types of droplets each having a different discharge amount from the multiple nozzles onto a medium to form an image having gradation of density in accordance with an input gradation value input to a liquid discharge apparatus, the input gradation value increasing from a first gradation portion to a second gradation portion higher than the first gradation portion. The controlling causes the liquid discharge head to selectively discharge the largest droplets of the two or more types of droplets from the multiple nozzles in the second gradation portion of the gradation value. The controlling also causes the liquid discharge head to decrease a number of non-discharge nozzles that do not discharge droplets in the multiple nozzles from the first gradation portion to the second gradation portion while increasing the number of non-discharge nozzles in a part of the first gradation portion.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

The present invention can be implemented in any convenient form, for example using dedicated hardware, or a mixture of dedicated hardware and software. The present invention may be implemented as computer software implemented by one or more networked processing apparatuses. The processing apparatuses include any suitably programmed apparatuses such as a general purpose computer, a personal digital assistant, a Wireless Application Protocol (WAP) or third-generation (3G)-compliant mobile telephone, and so on. Since the present invention can be implemented as software, each and every aspect of the present invention thus encompasses computer software implementable on a programmable device. The computer software can be provided to the programmable device using any conventional carrier medium (carrier means). The carrier medium includes a transient carrier medium such as an electrical, optical, microwave, acoustic or radio frequency signal carrying the computer code. An example of such a transient medium is a Transmission Control Protocol/Internet Protocol (TCP/IP) signal carrying computer code over an IP network, such as the Internet. The carrier medium may also include a storage medium for storing processor readable code such as a floppy disk, a hard disk, a compact disc read-only memory (CD-ROM), a magnetic tape device, or a solid state memory device.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

1. A liquid discharge apparatus comprising:
a liquid discharge head including multiple nozzles to discharge two or more types of droplets each having a different discharge amount from the multiple nozzles onto a medium to form an image having gradation of density in accordance with an input gradation value input to the liquid discharge apparatus, the input gradation value increasing from a first gradation portion to a second gradation portion higher than the first gradation portion; and
circuitry configured to:
cause the liquid discharge head to selectively discharge the largest droplets of the two or more types of droplets from the multiple nozzles in the second gradation portion of the gradation value, and
cause the liquid discharge head to decrease a number of non-discharge nozzles that do not discharge droplets in the multiple nozzles from the first gradation portion to the second gradation portion while increasing the number of non-discharge nozzles in a part of the first gradation portion.

2. The liquid discharge apparatus according to claim 1,
wherein the circuitry controls the liquid discharge head to linearly increase total discharge amount of two or more types of droplets discharged from the multiple nozzles with respect to an increase in the input gradation value input to the liquid discharge apparatus.

3. The liquid discharge apparatus according to claim 1,
wherein the circuitry controls the liquid discharge head to discharge the smallest droplets of the two or more types of droplets only when the gradation value is equal to or smaller than 13%.

4. The liquid discharge apparatus according to claim 1,
wherein the circuitry controls the liquid discharge head to discharge the smallest droplets of the two or more types of droplets only when the gradation value is equal to or smaller than 10%.

5. The liquid discharge apparatus according to claim 1,
wherein the circuitry causes the liquid discharge head to:
selectively discharge three or more types of droplets each having a different discharge amount from the multiple nozzles; and
discharge second smallest droplets among the three or more types of droplets from the multiple nozzles when the gradation value is equal to or smaller than 15%.

6. The liquid discharge apparatus according to claim 1,
wherein the circuitry causes the liquid discharge head to decrease the number of non-discharge nozzles from the second gradation portion to the first gradation portion at least in a part having the input gradation value of equal to or smaller than 20%.

7. The liquid discharge apparatus according to claim 1,
wherein the circuitry controls the liquid discharge head to discharge at least two or more types of droplets each a having different size from the multiple nozzles in a portion of the input gradation value in which the number of the non-discharge nozzles decreases from the first gradation portion to the second gradation portion in the input gradation value.

8. A liquid discharge device comprising:
the liquid discharge head according to claim 1; and
at least one of a head tank, a carriage, a supply mechanism, a maintenance mechanism, and a main-scanning moving mechanism.

9. A liquid discharge apparatus comprising:
the liquid discharge head according to claim 1; and
circuitry configured to drive the liquid discharge head to discharge liquid.

10. A liquid discharge method comprising:
controlling a liquid discharge head including multiple nozzles to discharge two or more types of droplets each having a different discharge amount from the multiple nozzles onto a medium to form an image having gradation of density in accordance with an input gradation value input to a liquid discharge apparatus, the input gradation value increasing from a first gradation portion to a second gradation portion higher than the first gradation portion;
causing the liquid discharge head to selectively discharge the largest droplets of the two or more types of droplets from the multiple nozzles in the second gradation portion of the gradation value; and
causing the liquid discharge head to decrease a number of non-discharge nozzles that do not discharge droplets in the multiple nozzles from the first gradation portion to the second gradation portion while increasing the number of non-discharge nozzles in a part of the first gradation portion.

11. A non-transitory recording medium storing a plurality of instructions which, when executed by one or more processors, causes the one or more processors to perform a method, comprising:
controlling a liquid discharge head including multiple nozzles to discharge two or more types of droplets each having a different discharge amount from the multiple nozzles onto a medium to form an image having gradation of density in accordance with an input gradation value input to a liquid discharge apparatus, the input gradation value increasing from a first gradation portion to a second gradation portion higher than the first gradation portion;
causing the liquid discharge head to selectively discharge the largest droplets of the two or more types of droplets from the multiple nozzles in the second gradation portion of the gradation value; and
causing the liquid discharge head to decrease a number of non-discharge nozzles that do not discharge droplets in the multiple nozzles from the first gradation portion to the second gradation portion while increasing the number of non-discharge nozzles in a part of the first gradation portion.
